(19) United States
(12) Patent Application Publication
(10) Pub. No.: US 2026/0184609 A1
(43) Pub. Date: Jul. 2, 2026

(54) Solar-Powered Copper Ion Generator, and Polarity Reversal Method and Electrode Depletion Determination Method Thereof

(71) Applicant: Ningbo SurgeEdge Management Co., Ltd, Ningbo City (CN)

(72) Inventors: Yingying YANG, Ningbo City (CN); Lidan YE, Ningbo City (CN)

(73) Assignee: Ningbo SurgeEdge Management Co., Ltd, Ningbo City (CN)

(21) Appl. No.: 19/399,187

(22) Filed: Nov. 24, 2025

(30) Foreign Application Priority Data
Jan. 2, 2025 (CN) 202520003579.0

(51) Int. Cl. C02F 1/461; C02F 1/00; C02F 103/42

(52) U.S. Cl. CPC C02F 1/46109; C02F 1/008; C02F 2103/42; C02F 2201/002; C02F 2201/4613; C02F 2201/46135; C02F 2201/4614; C02F 2201/46165; C02F 2303/04

(57) ABSTRACT

The disclosure provides a solar-powered copper ion generator, and a polarity reversal method and an electrode depletion determination method thereof. The solar-powered copper ion generator includes a main body and an electrode assembly. A dirt collection assembly is mounted on an outer side of the electrode assembly. The dirt collection assembly includes a filter basket and a dirt collection box. A drainage through hole is provided in the dirt collection box, and a bottom of the filter basket is provided with an inlet. A float is liftably mounted in the filter basket. The solar-powered copper ion generator, and the polarity reversal method and the electrode depletion determination method thereof disclosure overcomes the defect that dirt generated by the existing copper ion generator makes a pool dirty.

### TECHNICAL FIELD

The disclosure relates to the technical field of copper ion generators, and in particular to a solar-powered copper ion generator, and a polarity reversal method and an electrode depletion determination method thereof.

### BACKGROUND

A swimming pool is a pool where people engage in competitive swimming, fitness training, recreational activities, rehabilitation and medical treatments. The quality of its water is crucial for ensuring the health of swimmers. Typically, chlorine-containing substances are added into swimming pool water to maintain water quality and achieve disinfection. When chlorine is added in excess, the volatilized chlorine gas will do serious harm to humans and plants, and will corrode metal products and buildings. In order to solve the above problems, copper ion generators were developed. After electrolysis, positively charged copper ions and negatively charged cell walls of microorganisms combine to form electrostatic bonds. The formation of electrostatic bonds alters the permeability of cell walls and disrupts the normal uptake of nutrients by microorganisms, thereby achieving sterilization. Moreover, once copper ions enter the algae cells, they immediately attack the sulfur-containing amino acids in the proteins of the cells, so that photosynthesis cannot be carried out normally and the algae cells die.

When the existing copper ion generator is used, the electrodes produce a small amount of suspended dirt, and the generated dirt enters the pool, thereby compromising water clarity and resulting in a poor use effect.

### SUMMARY

### (I) Technical Problem to be Solved

In view of this, the disclosure provides a solar-powered copper ion generator, and a polarity reversal method and an electrode depletion determination method thereof, so as to overcome the defect that the dirt generated by the existing copper ion generator makes the pool dirty.

### (II) Technical Solution

In order to solve the technical problem, the disclosure provides a solar-powered copper ion generator, including a main body and an electrode assembly mounted on the main body. A dirt collection assembly is detachably mounted on an outer side of the electrode assembly. The dirt collection assembly includes a filter basket covering the outer side of the electrode assembly and a dirt collection box detachably mounted at a bottom of the filter basket. A drainage through hole in communication with the filter basket is provided in the dirt collection box, and the bottom of the filter basket is provided with an inlet. A float is liftably mounted in the filter basket, and the float is located right above the drainage through hole and is capable of opening and closing the inlet. When in use, the float rises to open the inlet, and dirt generated by the electrode assembly falls along an outer ring of the float and is collected in the dirt collection box through the inlet.

In some embodiments, the bottom of the filter basket is sleeved with a connecting seat, and the connecting seat is provided with a connecting seat flange. One end of the connecting seat extends into an inside of the filter basket. The connecting seat flange abuts against a lower end of the filter basket. The other end of the connecting seat extends to an outside of the filter basket and is threadedly connected to the dirt collection box. The inlet is provided in the connecting seat, and the inlet is trumpet-shaped with a large upper end and a small lower end.

In some embodiments, a center of the connecting seat is provided with a guide tube protruding upwards. A lower end of the guide tube is in communication with the drainage through hole, and the float is sleeved on the guide tube and slidable along an axial direction of the guide tube.

In some embodiments, the float includes a conical main body covering an upper side of the guide tube and a float seat fixed in the conical main body. A guide groove through which the guide tube runs is provided in the float seat. A diameter of the guide groove is greater than an outer diameter of the guide tube, so that the float is capable of moving horizontally relative to the guide tube.

In some embodiments, an upper end of the guide tube is annularly provided with a plurality of limiting protrusions at equal intervals. The limiting protrusions extend along a radial direction of the guide tube. The limiting protrusions are configured to define an upper limit of the float. The connecting seat is annularly provided with a plurality of connecting plates at equal intervals. The connecting plates are connected between the guide tube and the connecting seat. The connecting plates are configured to define a lower limit of the float.

In some embodiments, the upper end of the guide tube is annularly provided with a plurality of elastic plates at equal intervals. The plurality of limiting protrusions are arranged in one-to-one correspondence with the plurality of elastic plates.

In some embodiments, a drainage tube is vertically arranged at a center inside the dirt collection box. An annular dirt collection cavity is formed around the drainage tube in the dirt collection box, and the drainage through hole is provided in the drainage tube. The dirt collection box is made of a transparent material.

In some embodiments, a threaded seat is fixed to a lower end of the main body, and an upper side of the filter basket is provided with a connecting flange. The threaded seat is threadedly connected with a locking nut, and the locking nut fastens and locks the connecting flange, the electrode assembly and the threaded seat. The filter basket includes a cylindrical hollow support and a filter screen mounted on the hollow support. The connecting flange is arranged at an upper end of the hollow support.

In some embodiments, the electrode assembly includes an electrode holder, and a first electrode and a second electrode mounted on the electrode holder, and plug connectors are symmetrically mounted in the threaded seat. The first electrode and the second electrode are capable of being correspondingly plugged into the two plug connectors.

In some embodiments, an upper end of the main body is provided with a solar panel and a circuit board. The solar panel is located at an upper side of the circuit board, and the solar panel, the circuit board and the electrode assembly are electrically connected in sequence.

The circuit board is provided with a current control unit electrically connected to the electrode assembly. When in use, the current control unit supplies controlled voltage and current to the electrode assembly and controls the electrode assembly to undergo polarity reversal at regular time intervals. The circuit board is provided with a current detection unit and a control unit which are connected. The control unit is connected to the current control unit. The current detection unit is configured to detect an actual current of the electrode assembly, and the control unit determines a polarity reversal time and determines whether the electrode is depleted based on the actual current.

In some embodiments, the circuit board is provided with a voltage detection unit. The voltage detection unit is connected to the control unit. The circuit board is provided with a timer, a memory and a solar panel voltage detection unit which are respectively connected to the control unit.

Based on the same inventive concept, the disclosure further provides a polarity reversal method of a solar-powered copper ion generator, implemented based on the solar-powered copper ion generator. By detecting an actual current Iₖ of the electrode assembly, a polarity reversal time of the electrode assembly is determined based on the actual current Iₖ. The method specifically includes the following steps:
step S1: power-on: supplying power to the electrode assembly by the current control unit;
step S2: current detection: detecting the actual current Iₖ of the electrode assembly at T₁ time intervals, and recording a number of tests N and corresponding Iₖ;
step S3: calculation of Iₜₒₜₐₗ: accumulating, based on

$${I}_{total} = {\sum }_{k = 1}^{N} {I}_{k} , {I}_{k}$$

detected in each time interval to calculate Iₜₒₜₐₗ; and
step S4: determining whether Iₜₒₜₐₗ is equal to NₘₐₓIₘₐₓ, where Iₘₐₓ is a system-defined maximum current that does not produce excessive copper ions, and Nₘₐₓ is a maximum number of sampling periods when the current reaches Iₘₐₓ;
if so, controlling the electrode assembly to undergo polarity reversal; and
if not, repeating step S2 and step S3.

In some embodiments, in step S4, residual current is eliminated before the polarity reversal is performed, specifically including the following steps:
step S41: residual current elimination: eliminating the residual current in the electrode assembly by discharge for a time T₂ or by fast pulse inversion.

In some embodiments, Iₘₐₓ-60-80 mA.

Based on the same inventive concept, the disclosure further provides a polarity reversal method of a solar-powered copper ion generator, implemented based on the solar-powered copper ion generator. By detecting or calculating a copper ion concentration Fₘ near a cathode in the electrode assembly, a polarity reversal time of the electrode assembly is determined based on the copper ion concentration Fₘ. The method specifically includes the following steps:
step A1: power-on: supplying power to the electrode assembly by a current control unit, and controlling a current direction as from a first electrode to a second electrode;
step A2: calculation of Fₘ: respectively detecting, by the current detection unit and the voltage detection unit, an actual current Iₘ and an actual voltage Uₘ of the second electrode at T₃ time intervals, calculating Fₘ based on

$${F}_{m} = \frac{{I}_{m}}{{U}_{m}} ,$$

and recording a number of tests N and corresponding Fₘ;
step A3: determining whether N is greater than 2;
if so, performing a next step; and
if not, repeating step A2;
step A4: acquisition of K and R²: fitting a linear function of N Fₘ values by a least square method to obtain Fₘ=Kt+b, with a goodness of fit R²; and
step A5: determining whether K<−8.235,0.85≤R²<1;
if so, controlling the electrode assembly to undergo polarity reversal; and
if not, repeating step A2 to step A4.

Based on the same inventive concept, the disclosure further provides an electrode depletion determination method of a solar-powered copper ion generator, implemented based on the solar-powered copper ion generator. When a ratio of a consumed mass M of an electrode assembly to a preset initial mass Mᵢₙᵢₜᵢₐₗ of the electrode assembly reaches a predetermined threshold, it is determined that the electrode is depleted and an alarm is given. The method specifically includes the following steps:
step B1: current detection: detecting and recording, by the current detection unit, an actual current I_{γ} of the electrode assembly at T₄ time intervals;
step B2: calculation of M: accumulating, based on

$$M = \frac{{\sum }_{τ = 1}^{N} {I}_{τ} {T}_{4}}{{K}_{1}} \cdot {K}_{2} ,$$

the electric charge passed in each time interval to obtain the total electric charge, and converting the total electric charge into the consumed mass to calculate M; and
step B3: determining whether

$$\frac{M}{{M}_{initial}}$$

reaches the predetermined threshold;
if so, determining that the electrode is depleted and an alarm is given; and
if not, repeating step B1 and step B2.

In some embodiments, when the predetermined threshold is 90%, it is determined that the electrode is depleted.

### (III) Beneficial Effects

Compared with the prior art, the above-mentioned at least one technical solution used in the embodiments of this specification can at least achieve the following beneficial effects:

1) According to the solar-powered copper ion generator, the dirt collection assembly is added. Through the cooperation of the filter basket, the dirt collection box and the float, when the copper ion generator is put into water for use, the float rises to open the inlet, and the dirt generated by the electrode assembly is stopped by the filter basket, falls along the outer ring of the float and is finally collected in the dirt collection box through the inlet. When the copper ion generator is taken out of the water, the float descends to close the inlet, so as to prevent the dirt from leaking out of the dirt collection box. The dirt collection assembly can collect impurities generated by the electrodes, which prevents the impurities from entering the pool and affecting the water quality. The float is provided. On the one hand, the float can block the drainage through hole to prevent the dirt from entering the swimming pool through the drainage through hole, and on the other hand, when in use, the float can shake with the water flow to better discharge copper ions generated by the electrode assembly from the filter basket, thereby improving the sterilization and disinfection effect.

2) The polarity reversal method is simple in steps and convenient to operate. According to the detected current data, polarity reversal can be performed in time before excessive copper ions are generated, so as to prevent precipitation and excessive copper consumption, prolong the service life, make the swimming pool cleaner and more attractive, and reduce subsequent filtering procedures. Moreover, according to the detected current and voltage data in combination with calculation of the copper ion concentration, polarity reversal can be performed in time before copper reduction, so that more copper can be reused to become copper ions.

3) According to the electrode depletion determination method, the consumed copper can be calculated according to the detection data, and once the predetermined threshold is reached, it is determined that the electrode is depleted and an alarm is given, so that the electrodes can be replaced in time.

### BRIEF DESCRIPTION OF FIGURES

To describe the technical solutions in embodiments of this application more clearly, the following briefly describes the accompanying drawings required in the embodiments of this application. Apparently, the accompanying drawings in the following description show merely some embodiments of this application, and a person of ordinary skill in the art may still derive other accompanying drawings from these accompanying drawings without creative efforts.

FIG. 1 is a three-dimensional view of a solar-powered copper ion generator according to the disclosure;

FIG. 2 is a three-dimensional view of the solar-powered copper ion generator from another angle according to the disclosure;

FIG. 3 is an exploded view of the solar-powered copper ion generator according to the disclosure;

FIG. 4 is a sectional view of the solar-powered copper ion generator after a float descends according to the disclosure;

FIG. 5 is a three-dimensional view of a main body of the solar-powered copper ion generator according to the disclosure;

FIG. 6 is a three-dimensional view of the float of the solar-powered copper ion generator according to the disclosure;

FIG. 7 is a three-dimensional view of a connecting seat of the solar-powered copper ion generator according to the disclosure;

FIG. 8 is a three-dimensional view of the connecting seat connected with a float seat in the solar-powered copper ion generator according to the disclosure;

FIG. 9 is a three-dimensional view of a dirt collection box of the solar-powered copper ion generator according to the disclosure;

FIG. 10 is a three-dimensional view of an electrode assembly of the solar-powered copper ion generator according to the disclosure; and

FIG. 11 is a sectional view of the solar-powered copper ion generator after the float rises according to the disclosure;

FIG. 12 is a schematic structural diagram showing the connections between units on a circuit board in the solar-powered copper ion generator according to the disclosure;

FIG. 13 is a structural flowchart of a polarity reversal method of a solar-powered copper ion generator according to the disclosure;

FIG. 14 is a structural flowchart of another polarity reversal method of a solar-powered copper ion generator according to the disclosure; and

FIG. 15 is a structural flowchart of an electrode depletion determination method of a solar-powered copper ion generator according to the disclosure.

The reference numerals in the figures correspond to the following components: 1, main body; 11, threaded seat; 12, locking nut; 13, solar panel; 14, circuit board; 141, current detection unit; 142, control unit; 143, voltage detection unit; 144, timer; 145, memory; 146, solar panel voltage detection unit; 147, current control unit; 2, electrode assembly; 21, electrode holder; 22, first electrode; 23, second electrode; 24, plug connector; 3, dirt collection assembly; 31, filter basket; 32, dirt collection box; 33, float; 34, connecting seat; 311, connecting flange; 312, hollow support; 321, drainage through hole; 322, drainage tube; 323, dirt collection cavity; 331, conical main body; 332, float seat; 333, guide groove; 341, inlet; 342, guide tube; 343, limiting protrusion; 344, connecting plate; 345, elastic plate; and 346, connecting seat flange.

### DETAILED DESCRIPTION

The embodiments of this application will be described in detail below in conjunction with accompanying drawings.

The implementations of this application are described below through specific embodiments. Those skilled in the art can easily understand the other advantages and effects of this application from the content disclosed in the specification. It is apparent that the described embodiments are a part of the embodiments of the present application, rather than all of the embodiments. This application may also be implemented or applied through other different specific implementations, and various details in the specification may also be modified or changed based on different viewpoints and applications without departing from the spirit of this application. It should be noted that the embodiments below and the features in the embodiments can be combined with each other in case of no conflict. All other embodiments obtained by a person of ordinary skill in the art based on the embodiments of this application without creative efforts shall fall within the protection scope of this application.

It is noted that various aspects of the embodiments within the scope of the appended claims are described below. It is apparent that the aspects described herein can be embodied in a wide variety of forms, and any specific structure and/or function described herein is merely illustrative. Based on this application, those skilled in the art should understand that one aspect described herein may be implemented independently of any other aspect, and two or more of these aspects may be combined in various ways. For example, device and/or methods may be implemented using any number of aspects described herein. In addition, the device and/or the method may be implemented using structures and/or functionalities other than one or more of the aspects described herein.

It should also be noted that the drawings provided in the following embodiments only schematically illustrate the basic concept of this application, and the drawings show only the components related to this application instead of being drawn according to the quantity, shape and size of the components in actual implementation. In actual implementation, the shape, quantity and proportion of the components may be changed at will, and the layout of components may be more complicated.

In addition, in the following description, specific details are provided to facilitate a thorough understanding of the examples. However, it will be understood by those skilled in the art that this application may be implemented without these specific details.

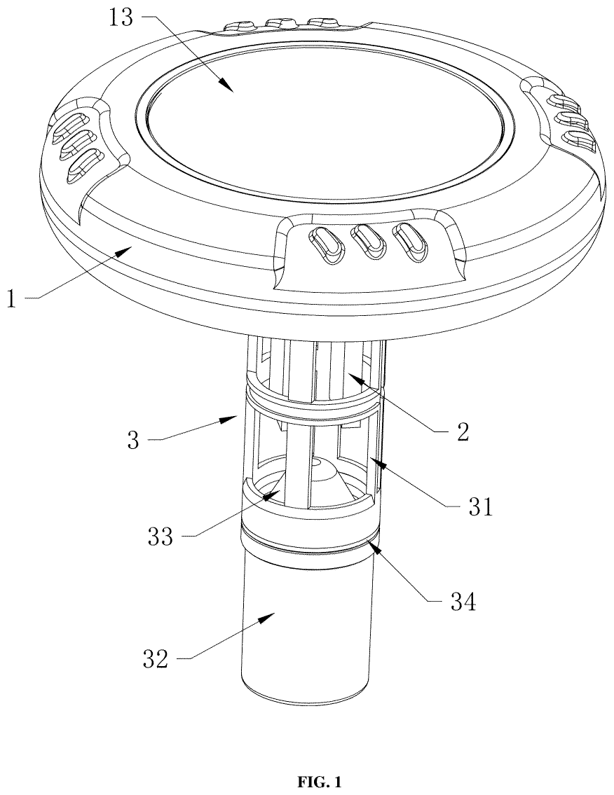

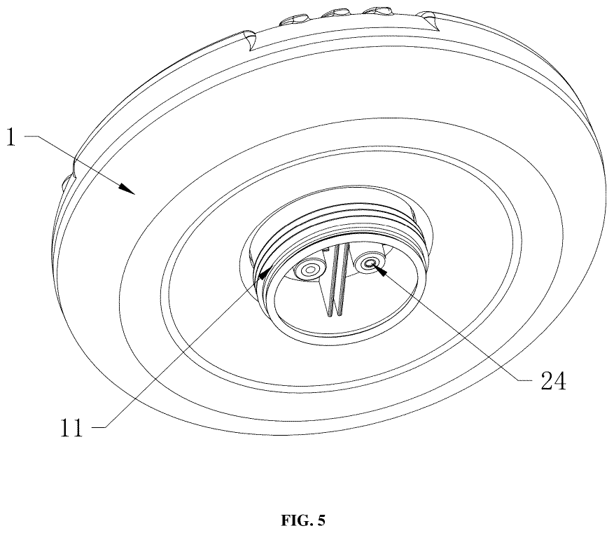

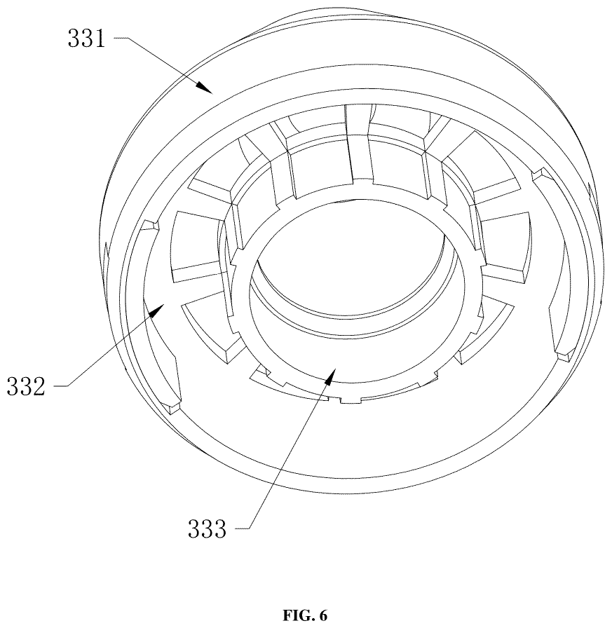

Referring to FIG. 1 to FIG. 11, the disclosure provides a solar-powered copper ion generator, including a main body 1 and an electrode assembly 2 detachably mounted on the main body 1. A dirt collection assembly 3 is detachably mounted on an outer side of the electrode assembly 2. The dirt collection assembly 3 is configured to collect dirt generated by the electrode assembly 2, preventing the dirt from entering the pool and ensuring the water quality of the swimming pool.

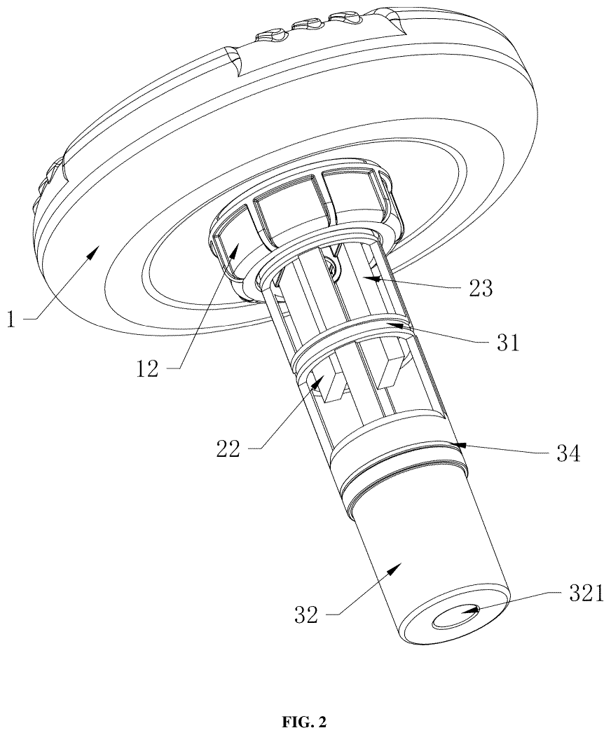

Referring to FIG. 2 to FIG. 4, the dirt collection assembly 3 includes a filter basket 31 covering the outer side of the electrode assembly 2 and a dirt collection box 32 detachably mounted at a bottom of the filter basket 31. A top of the filter basket 31 is detachably connected with the main body 1. The electrode assembly 2 is located inside the filter basket 31. A drainage through hole 321 in communication with the filter basket 31 is provided in the dirt collection box 32. The drainage through hole 321 is trumpet-shaped. By providing the drainage through hole 321, the copper ion generator can be put in or moved out of water conveniently, avoiding the pressure generated by air. The bottom of the filter basket 31 is provided with an inlet 341. The inlet 341 is in communication with the dirt collection box 32. A float 33 is liftably mounted in the filter basket 31. The float 33 is located right above the drainage through hole 321 and is capable of opening and closing the inlet 341. The float 33 can block the drainage through hole 321, which can prevent dirt from entering the swimming pool through the drainage through hole 321 when in use. An outer diameter of the float 33 is less than an inner diameter of the filter basket 31, so that a gap is reserved, which facilitates the dirt to fall along an outer ring of the float 33.

When the copper ion generator is put into water for use, under the action of buoyancy, the float 33 rises to open the inlet 341, and the dirt generated by the electrode assembly 2 is stopped by the filter basket 31, falls along the outer ring of the float 33, and is finally collected in the dirt collection box 32 through the inlet 341. When the copper ion generator is moved out of the water, under the action of gravity, the float 33 descends to close the inlet 341, which can prevent the dirt from leaking out of the dirt collection box 32 and provide a good use effect.

In some embodiments, as shown in FIG. 2 to FIG. 4, in order to facilitate the connection, the bottom of the filter basket 31 is sleeved with a connecting seat 34. The connecting seat 34 is provided with a connecting seat flange 346. One end of the connecting seat 34 extends into an inside of the filter basket 31 and is connected to the filter basket 31 by interference fit, threaded connection or snap fit. The connecting seat flange 346 abuts against a lower end of the filter basket 31. The other end of the connecting seat 34 extends to an outside of the filter basket 31 and is threadedly connected to the dirt collection box 32. By using the threadedly connected dirt collection box 32, the dirt collection box 32 can be mounted and dismounted conveniently, so that the dirt in the dirt collection box 32 can be removed conveniently. The inlet 341 is provided in the connecting seat 34, and the inlet 341 is trumpet-shaped with a large upper end and a small lower end. By using the trumpet-shaped inlet 341, the inlet 341 can be opened and closed by the rising and descending of the float 33, thereby ensuring the feasibility of the structure.

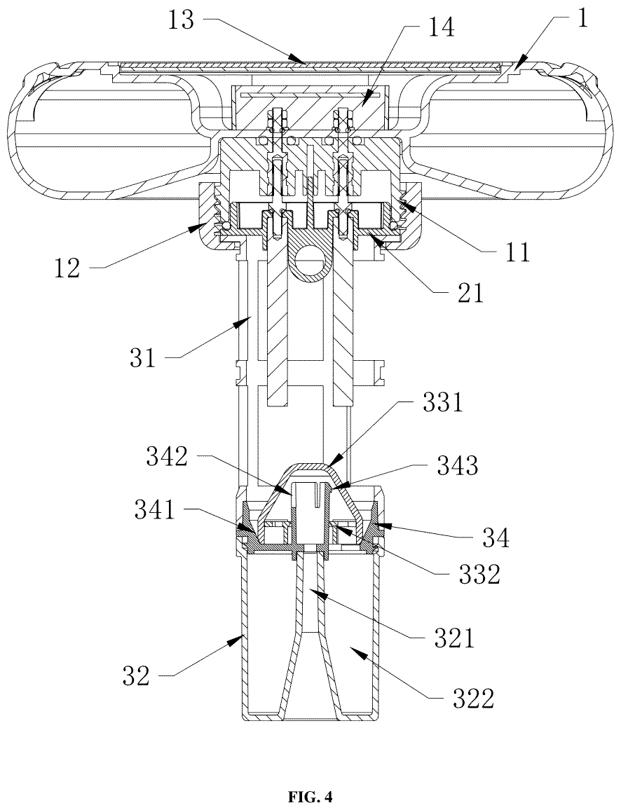

In some embodiments, as shown in FIG. 4 and FIG. 6 to FIG. 8, a center of the connecting seat 34 is provided with a guide tube 342 protruding upwards. A lower end of the guide tube 342 is in communication with the drainage through hole 321. The float 33 is sleeved on the guide tube 342 and slidable along an axial direction of the guide tube 342. A material density of the float 33 needs to be less than or equal to a density of water. For example, the float 33 may be made of PP, to ensure that the float 33 can float in water when in use. The float 33 includes a conical main body 331 covering an upper side of the guide tube 342 and a float seat 332 fixed in the conical main body 331. The float seat 332 is slidably sleeved on the guide tube 342 and is capable of moving up and down along the guide tube 342.

A guide groove 333 through which the guide tube 342 runs is provided in the float seat 332, and a diameter of the guide groove 333 is greater than that of the guide tube 342, so that the float 33 is capable of moving horizontally relative to the guide tube 342. With this structure, when in use, the float can shake with the water flow to better discharge copper ions generated by the electrode assembly from the filter basket, thereby improving the sterilization and disinfection effect.

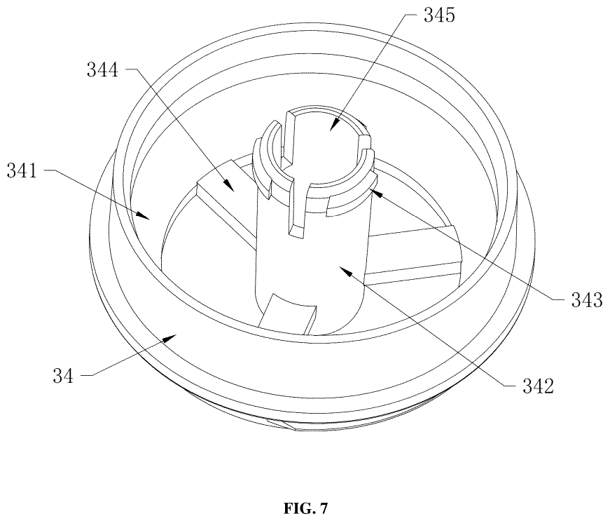

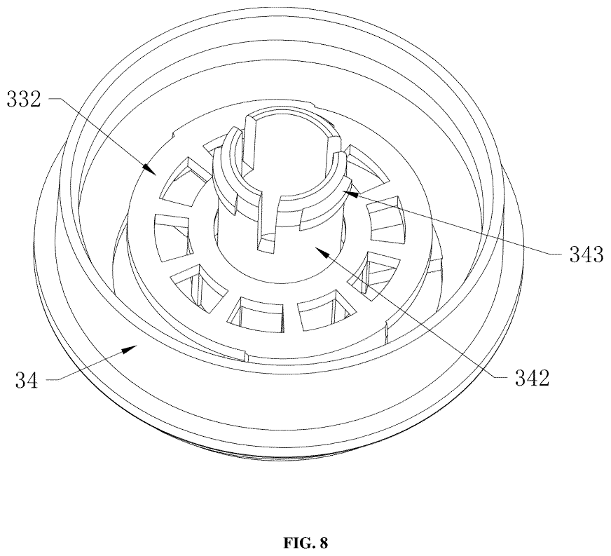

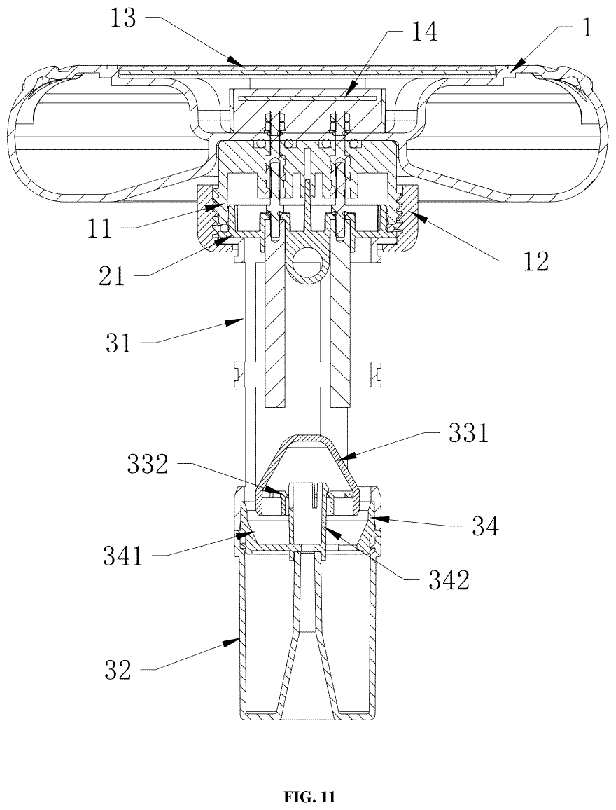

In some embodiments, as shown in FIG. 4, FIG. 7 and FIG. 8, an upper end of the guide tube 342 is annularly provided with a plurality of limiting protrusions 343 at equal intervals. The limiting protrusions 343 extend along a radial direction of the guide tube 342. The limiting protrusions 343 are configured to define an upper limit of the float 33. The upper end of the guide tube 342 is annularly provided with a plurality of elastic plates 345 at equal intervals. The plurality of elastic plates 345 are arranged in one-to-one correspondence with the elastic plates 345. The limiting protrusions 343 are arranged on corresponding elastic plates 345. The elastic plates 345, the limiting protrusions 343, the guide tube 342 and the connecting seat 34 are plastic members with an integrated structure. A through hole is provided between every two adjacent elastic plates 345, so that the elastic plates 345 have a degree of elasticity. By providing the elastic plates 345, the float seat 332 can be conveniently sleeved on the guide tube 342. The connecting seat 34 is annularly provided with a plurality of connecting plates 344 at equal intervals. The connecting plates 344 are connected between the guide tube 342 and the connecting seat 34, and the connecting plates 344 are configured to define a lower limit of the float 33. When the float 33 rises, the upper limit of the float 33 is defined by the limiting protrusions 343 (as shown in FIG. 11). When the float 33 descends, the lower limit of the float 33 is defined by the connecting plates 344 (as shown in FIG. 4).

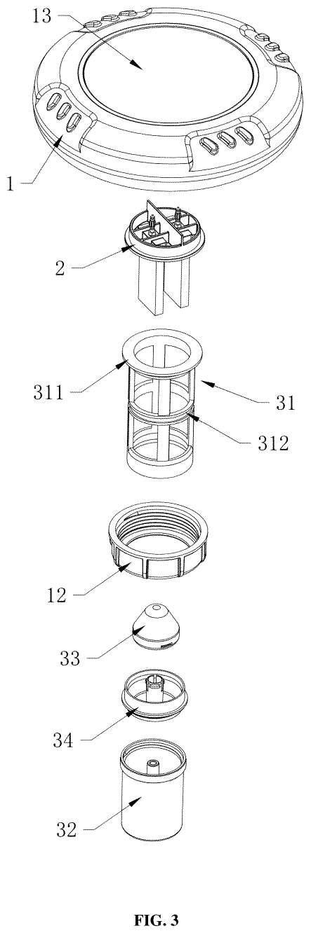

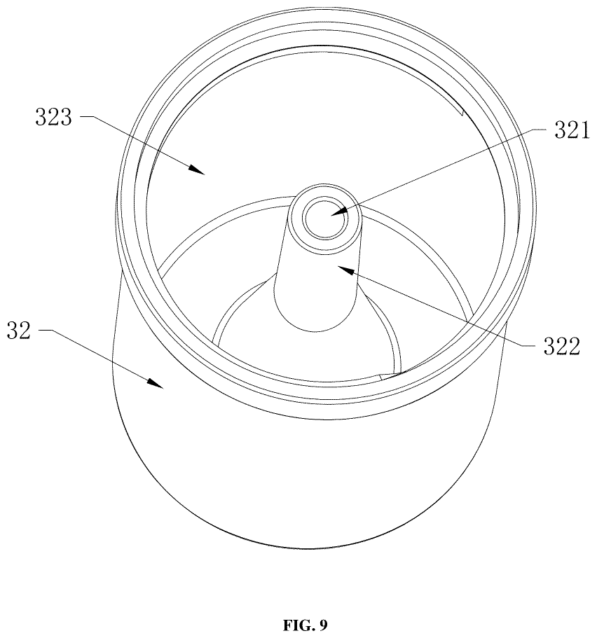

In some embodiments, as shown in FIG. 3, FIG. 4 and FIG. 9, a drainage tube 322 is vertically arranged at a center inside the dirt collection box 32. An annular dirt collection cavity 323 is formed around the drainage tube 322 in the dirt collection box 32. The dirt collection cavity 323 is configured to store dirt. The drainage through hole 321 is provided in the drainage tube 322. The dirt collection box 32 is made of a transparent material. With the dirt collection box 32 made of the transparent material, it is convenient for observing the dirt stored in the dirt collection box 32 and cleaning the dirt in time.

In some embodiments, as shown in FIG. 3 to FIG. 5, a threaded seat 11 is fixed to a lower end of the main body 1, and an upper side of the filter basket 31 is provided with a connecting flange 311. The threaded seat 11 is threadedly connected with a locking nut 12, and the locking nut 12 fastens and locks the connecting flange 311, the electrode assembly 2 and the threaded seat 11. The filter basket 31 includes a cylindrical hollow support 312 and a filter screen mounted on the hollow support 312. The connecting flange 311 is arranged at an upper end of the hollow support 312.

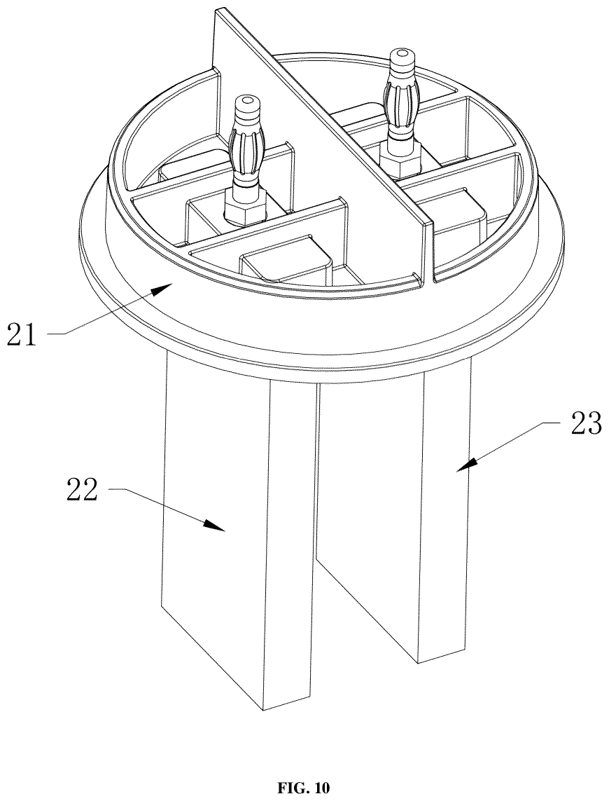

In some embodiments, as shown in FIG. 3, FIG. 4 and FIG. 10, the electrode assembly 2 includes an electrode holder 21, and a first electrode 22 and a second electrode 23 mounted on the electrode holder 21. The first electrode 22 and the second electrode 23 have the same structure and are arranged at an interval. Plug connectors 24 are symmetrically mounted in the threaded seat 11. The first electrode 22 and the second electrode 23 are capable of being correspondingly plugged into the two plug connectors 24. The first electrode and the second electrode have the same structure and size, and are both made of copper. The two electrodes may also be made of a copper silver alloy. An upper end of the main body 1 is provided with a solar panel 13 and a circuit board 14. The solar panel 13 is located at an upper side of the circuit board 14, and the solar panel 13, the circuit board 14 and the electrode assembly 2 are electrically connected in sequence.

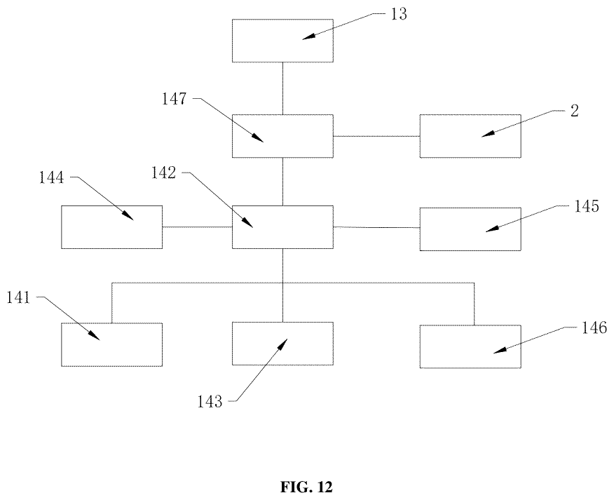

In some embodiments, as shown in FIG. 4 and FIG. 12, the circuit board 14 is provided with a current control unit 147 electrically connected to the electrode assembly 2. When in use, the solar panel 13 supplies power to the circuit board 14, and the current control unit 147 supplies controlled voltage and current to the electrode assembly 2 and controls the electrode assembly 2 to undergo polarity reversal at regular time intervals. With this structure, by providing the current control unit, the two copper electrodes can work and generate copper ions within reasonable voltage and current. This is because excessively high voltage and current will consume copper unreasonably, and excessive copper precipitation will produce ineffective copper peeling, shortening the service life of the electrodes.

In some embodiments, as shown in FIG. 12, the circuit board 14 is provided with the current detection unit 141 and the control unit 142 which are connected. The control unit 142 is connected to the current control unit 147. The current detection unit 141 is configured to detect an actual current of the electrode assembly 2, and the control unit 142 determines a polarity reversal time and determines whether the electrode is depleted based on the actual current.

In an example, as shown in FIG. 12, the circuit board 14 is provided with the voltage detection unit 143. The voltage detection unit 143 is connected to the control unit 142. The control unit may also calculate a copper ion concentration of a cathode based on the actual current and an actual voltage, so as to determine the polarity reversal time based on the copper ion concentration. The circuit board 14 is provided with a timer 144, a memory 145 and a solar panel voltage detection unit 146 which are respectively connected to the control unit 142. The timer is used for timing such that detection can be performed at the same time. The memory is a non-volatile memory for storing detection data of each detection unit.

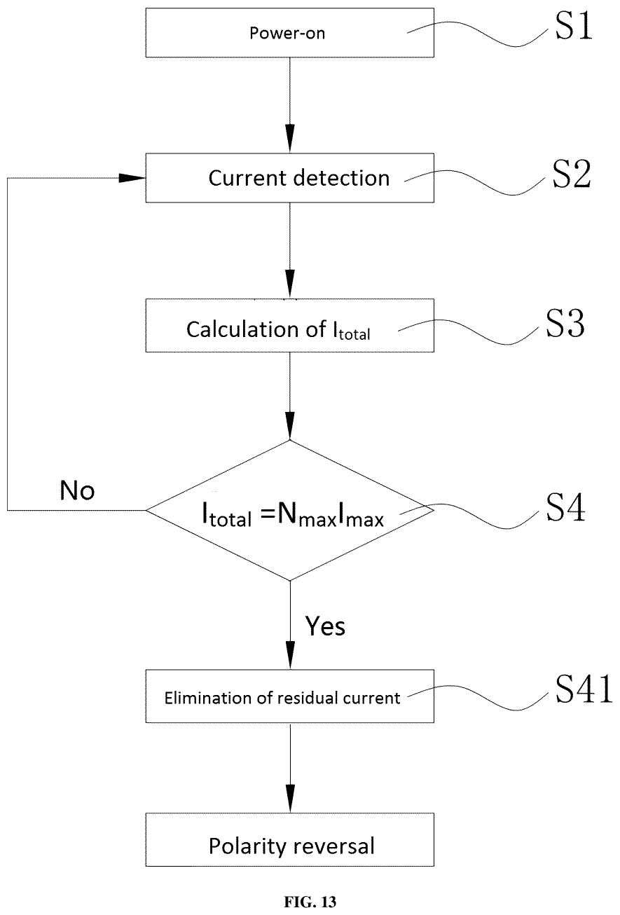

As shown in FIG. 13, based on the same inventive concept, the disclosure further provides a polarity reversal method of a solar-powered copper ion generator, implemented based on the solar-powered copper ion generator. By detecting an actual current Iₖ of the electrode assembly 2, a polarity reversal time of the electrode assembly 2 is determined based on the actual current Iₖ. The method specifically includes the following steps:
Step S1: power-on: the solar panel 13 supplies power to the circuit board 14, and the current control unit 147 on the circuit board 14 supplies power to the electrode assembly 2, and controls a current direction as from a first electrode 22 to a second electrode 23.
Step S2: current detection: the current detection unit 141 detect the actual current Iₖ of the electrode assembly 2 at T₁ time intervals, and a number of tests N and corresponding Iₖ are recorded, where T₁ may be 1 s.
Step S3: calculation of Iₜₒₜₐₗ: based on

$${I}_{total} = {\sum }_{k = 1}^{N} {I}_{k} ,$$

Iₖ detected in each time interval is accumulated, i.e., Iₜₒₜₐₗ=I₁+I₂+I₃+ . . . . I_{N}, to calculate Iₜₒₜₐₗ.
Step S4: whether Iₜₒₜₐₗ is equal to NₘₐₓIₘₐₓ is determined, where Iₘₐₓ is a system-defined maximum current that does not produce excessive copper ions, and Nₘₐₓ is a maximum number of sampling periods when the current reaches Iₘₐₓ;
if so, the electrode assembly 2 is controlled to undergo polarity reversal, i.e., the current control unit 147 controls the current direction as from the second electrode 23 to the first electrode 22; and
if not, step S2 and step S3 are repeated.

In step S4, residual current is eliminated before the polarity reversal is performed, specifically including the following steps:

Step S41: residual current elimination: the residual current in the electrode assembly 2 is eliminated by discharge for a time T₂ or by fast pulse inversion. T₂ may be 5 s, a frequency of the fast pulse inversion may be 200 Hz, and a duty cycle is 1/3

Iₘₐₓ=60-80 mA. Iₘₐₓ is a system-defined maximum current that does not produce excessive copper ions, which is mainly related to pH of water in the pool. The pH of water in the pool is 6.8-8.2, so it can be determined that Iₘₐₓ is 60-80 mA through testing.

The polarity reversal method is implemented mainly based on the following principle: based on formula Q=It, where Q is the quantity of electricity flowing through a cross-sectional area of the copper electrode, I is an electrolysis current, and t is a power-on time, and based on Q=∫Idt=Iₘₐₓ·Tₘₐₓ, where Iₘₐₓ is the system-defined maximum current that does not produce excessive copper ions, and Tₘₐₓ is a maximum time of electrolysis at Iₘₐₓ, i.e., I₁T₁+I₂T₁+I₃T₁+ . . . . I_{N}T₁=Iₘₐₓ·NₘₐₓT₁,

$${\sum }_{k = 1}^{N} {I}_{k} = {N}_{max} {I}_{max}$$

is obtained finally, where Nₘₐₓ is a maximum number of sampling periods when the current reaches Iₘₐₓ.

The polarity reversal method of a solar-powered copper ion generator is simple in steps and convenient to operate. According to the detected current data, polarity reversal can be performed in time before excessive copper ions are generated, so as to prevent precipitation and excessive copper consumption, prolong the service life, make the swimming pool cleaner and more attractive, and reduce subsequent filtering procedures.

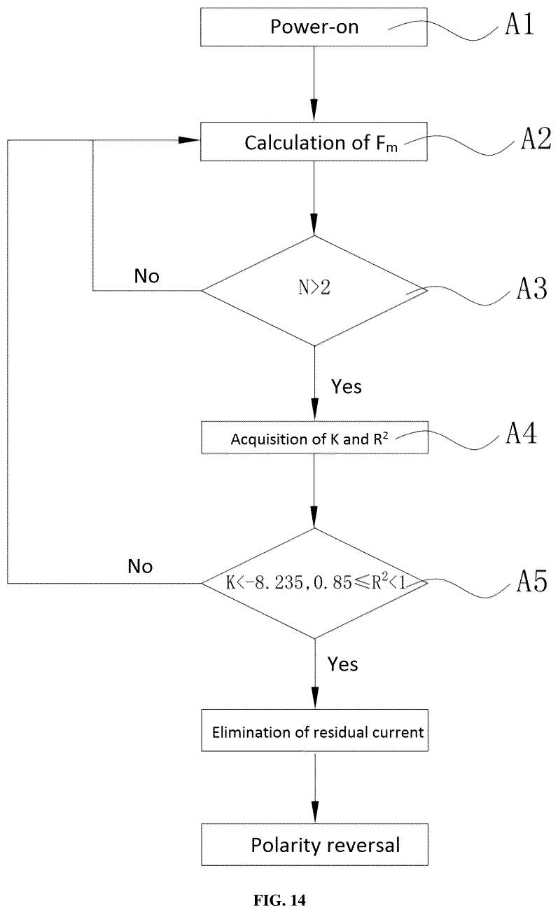

As shown in FIG. 14, based on the same inventive concept, the disclosure further provides another polarity reversal method of a solar-powered copper ion generator, implemented based on the solar-powered copper ion generator. By detecting or calculating a copper ion concentration Fₘ near a cathode in the electrode assembly 2, a polarity reversal time of the electrode assembly 2 is determined based on the copper ion concentration Fₘ. The method specifically includes the following steps:
Step A1: power-on: a current control unit 147 supplies power to the electrode assembly 2, and controls a current direction as from a first electrode 22 to a second electrode 23.
Step A2: calculation of Fₘ: the current detection unit 141 and the voltage detection unit 143 respectively detect an actual current Iₘ and an actual voltage Uₘ of the second electrode 23 at T₃ time intervals, Fₘ is calculated based on

$${F}_{m} = \frac{{I}_{m}}{{U}_{m}} ,$$

and a number of tests N and corresponding Fₘ are recorded, where T₃ may be 1 s.

Step A3: whether N is greater than 2 is determined.

If so, a next step is performed.

If not, step A2 is repeated.

Step A4: acquisition of K and R²: a linear function of N Fₘ values is fitted by a least square method to obtain Fₘ=Kt+b, with a goodness of fit R².

Step A5: whether K<−8.235,0.85≤R^{2<1} is determined.

If so, the electrode assembly 2 is controlled to undergo polarity reversal, i.e., the current control unit 147 controls the current direction as from the second electrode 23 to the first electrode 22. In order to ensure the calculation accuracy of polarity reversal, the residual current in the electrode assembly 2 may be eliminated by discharge for a time or by fast pulse inversion.

If not, step A2 to step A4 are repeated.

According to the polarity reversal method of a solar-powered copper ion generator, by determining the polarity reversal time of the electrode assembly based on the copper ion concentration, polarity reversal can be performed in time before copper reduction, so that more copper can be reused to become copper ions.

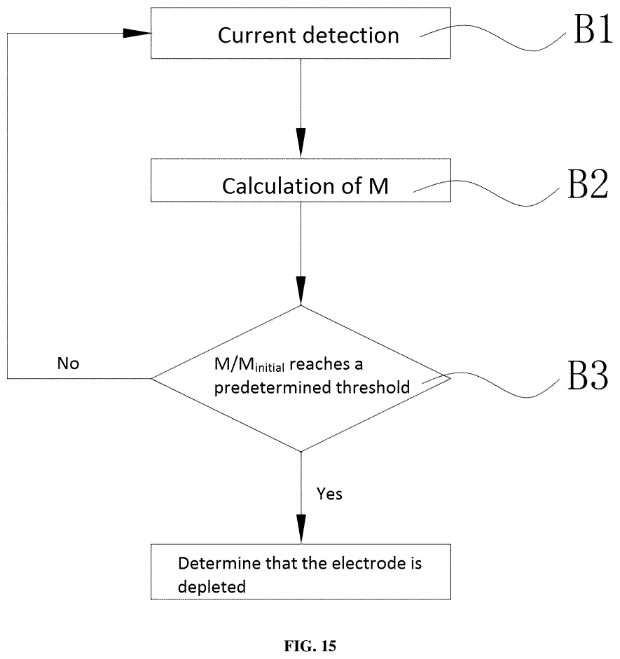

As shown in FIG. 15, based on the same inventive concept, the disclosure further provides an electrode depletion determination method of a solar-powered copper ion generator, implemented based on the solar-powered copper ion generator. When a ratio of a consumed mass M of an electrode assembly 2 to a preset initial mass Mᵢₙᵢₜᵢₐₗ of the electrode assembly 2 reaches a predetermined threshold, it is determined that the electrode is depleted and an alarm is given. In this embodiment, when the predetermined threshold is equal to 90%, it is determined that the electrode is depleted.

The method specifically includes the following steps:
Step B1: current detection: a current detection unit 141 detects and records an actual current I_{τ} of the electrode assembly 2 at T₄ time intervals, where T₄ may be 1 s.
Step B2: calculation of M: based on

$$M = \frac{{\sum }_{τ = 1}^{N} {I}_{τ} {T}_{4}}{{K}_{1}} \cdot {K}_{2} ,$$

the electric charge passed in each time interval is accumulated to obtain the total electric charge, and the total electric charge is converted into the consumed mass to calculate M, where K₁=96489, and K₂=128.
Step B3: whether

$$\frac{M}{{M}_{initial}}$$

reaches the predetermined threshold is determined, where Mᵢₙᵢₜᵢₐₗ is the system-preset initial weight of the electrode.

If so, it is determined that the electrode is depleted and an alarm is given.

If not, step B1 and step B2 are repeated.

The electrode depletion determination method is implemented mainly based on the following principle: based on formula Q=It, where Q is the quantity of electricity flowing through a cross-sectional area of the copper electrode, I is an electrolysis current, and t is an power-on time, and based on Cu−2e=Cu²⁺ and Q=∫Idt in the system, a Q value is obtained. Since 1 mol of electrons is equivalent to a Q value of 96489 coulombs, the relationship between current and time required to consume M grams of Cu is:

$$M = \frac{{\sum }_{τ = 1}^{N} {I}_{τ} {T}_{4}}{96489} \cdot 128.$$

According to the electrode depletion determination method of a solar-powered copper ion generator, the consumed copper can be calculated according to the detected data, and once the predetermined threshold is reached, it is determined that the electrode is depleted and an alarm is given, so that the electrodes can be replaced in time.

For the same or similar parts between the embodiments in the specification, reference may be made to each other. Each embodiment focuses on differences from other embodiments. In particular, for the embodiments described later, the description is relatively simple, and for relevant contents, reference may be made to part of the description of the previous embodiment.

The foregoing descriptions are merely specific implementations of this application, but the protection scope of this application is not limited thereto. Any variation or replacement readily figured out by those skilled in the art within the technical scope disclosed in this application shall fall within the protection scope of this application. Therefore, the protection scope of this application shall be subject to the protection scope of the claims.

What is claimed is:

1. A solar-powered copper ion generator, comprising a main body (1) and an electrode assembly (2) mounted on the main body (1), wherein a dirt collection assembly (3) is detachably mounted on an outer side of the electrode assembly (2), the dirt collection assembly (3) comprising a filter basket (31) covering the outer side of the electrode assembly (2) and a dirt collection box (32) detachably mounted at a bottom of the filter basket (31), a drainage through hole (321) in communication with the filter basket (31) is provided in the dirt collection box (32), and the bottom of the filter basket (31) is provided with an inlet (341); a float (33) is liftably mounted in the filter basket (31), and the float (33) is located right above the drainage through hole (321) and is capable of opening and closing the inlet (341); and when in use, the float (33) rises to open the inlet (341), and dirt generated by the electrode assembly (2) falls along an outer ring of the float (33) and is collected in the dirt collection box (32) through the inlet (341).

2. The solar-powered copper ion generator according to claim 1, wherein the bottom of the filter basket (31) is sleeved with a connecting seat (34), and the connecting seat (34) is provided with a connecting seat flange (346); one end of the connecting seat (34) extends into an inside of the filter basket (31), the connecting seat flange (346) abuts against a lower end of the filter basket (31), and the other end of the connecting seat (34) extends to an outside of the filter basket (31) and is threadedly connected to the dirt collection box (32); and the inlet (341) is provided in the connecting seat (34), and the inlet (341) is trumpet-shaped with a large upper end and a small lower end.

3. The solar-powered copper ion generator according to claim 2, wherein a center of the connecting seat (34) is provided with a guide tube (342) protruding upwards, a lower end of the guide tube (342) is in communication with the drainage through hole (321), and the float (33) is sleeved on the guide tube (342) and slidable along an axial direction of the guide tube (342).

4. The solar-powered copper ion generator according to claim 3, wherein the float (33) comprises a conical main body (331) covering an upper side of the guide tube (342) and a float seat (332) fixed in the conical main body (331), a guide groove (333) through which the guide tube (342) runs is provided in the float seat (332); and a diameter of the guide groove (333) is greater than an outer diameter of the guide tube (342), so that the float (33) is capable of moving horizontally relative to the guide tube (342).

5. The solar-powered copper ion generator according to claim 3, wherein an upper end of the guide tube (342) is annularly provided with a plurality of limiting protrusions (343) at equal intervals, the limiting protrusions (343) extending along a radial direction of the guide tube (342), and the limiting protrusions (343) are configured to define an upper limit of the float (33); and the connecting seat (34) is annularly provided with a plurality of connecting plates (344) at equal intervals, the connecting plates (344) is connected between the guide tube (342) and the connecting seat (34), and the connecting plates (344) are configured to define a lower limit of the float (33).

6. The solar-powered copper ion generator according to claim 5, wherein the upper end of the guide tube (342) is annularly provided with a plurality of elastic plates (345) at equal intervals, and the plurality of limiting protrusions (343) are arranged in one-to-one correspondence with the plurality of elastic plates (345).

7. The solar-powered copper ion generator according to claim 1, wherein a drainage tube (322) is vertically arranged at a center inside the dirt collection box (32), an annular dirt collection cavity (323) is formed around the drainage tube (322) in the dirt collection box (32), and the drainage through hole (321) is provided in the drainage tube (322); the dirt collection box (32) is made of a transparent material; and a material density of the float (33) is less than or equal to a density of water.

8. The solar-powered copper ion generator according to claim 1, wherein a threaded seat (11) is fixed to a lower end of the main body (1), an upper side of the filter basket (31) is provided with a connecting flange (311), the threaded seat (11) is threadedly connected with a locking nut (12), and the locking nut (12) fastens and locks the connecting flange (311), the electrode assembly (2) and the threaded seat (11); and
the filter basket (31) comprises a cylindrical hollow support (312) and a filter screen mounted on the hollow support (312), and the connecting flange (311) is arranged at an upper end of the hollow support (312).

9. The solar-powered copper ion generator according to claim 8, wherein the electrode assembly (2) comprises an electrode holder (21), and a first electrode (22) and a second electrode (23) mounted on the electrode holder (21), plug connectors (24) are symmetrically mounted in the threaded seat (11), and the first electrode (22) and the second electrode (23) are capable of being correspondingly plugged into the two plug connectors (24).

10. The solar-powered copper ion generator according to claim 1, wherein an upper end of the main body (1) is provided with a solar panel (13) and a circuit board (14), the solar panel (13) is located at an upper side of the circuit board (14), and the solar panel (13), the circuit board (14) and the electrode assembly (2) are electrically connected in sequence;
the circuit board (14) is provided with a current control unit (147) electrically connected to the electrode assembly (2); when in use, the current control unit (147) supplies controlled voltage and current to the electrode assembly (2) and controls the electrode assembly (2) to undergo polarity reversal at regular time intervals; the circuit board (14) is provided with a current detection unit (141) and a control unit (142) which are connected, and the control unit (142) is connected to the current control unit (147); and the current detection unit (141) is configured to detect an actual current of the electrode assembly (2), and the control unit (142) determines a polarity reversal time and determines whether the electrode is depleted based on the actual current.

11. The solar-powered copper ion generator according to claim 10, wherein the circuit board (14) is provided with a voltage detection unit (143), and the voltage detection unit (143) is connected to the control unit (142); and the circuit board (14) is provided with a timer (144), a memory (145) and a solar panel voltage detection unit (146) which are respectively connected to the control unit (142).

12. A polarity reversal method of a solar-powered copper ion generator, implemented based on the solar-powered copper ion generator according to claim 10, wherein by detecting an actual current Iₖ of the electrode assembly (2), a polarity reversal time of the electrode assembly (2) is determined based on the actual current Iₖ; and the method specifically comprises the following steps:
step S1: power-on: supplying power to the electrode assembly (2) by a current control unit (147);
step S2: current detection: detecting the actual current Iₖ of the electrode assembly (2) at T₁ time intervals, and recording a number of tests N and corresponding Iₖ;
step S3: calculation of Iₜₒₜₐₗ: accumulating, based on
$${I}_{total} = {\sum }_{k = 1}^{N} {I}_{k} , {I}_{k}$$
detected in each time interval to calculate Iₜₒₜₐₗ; and
step S4: determining whether Iₜₒₜₐₗ is equal to NₘₐₓIₘₐₓ, wherein Iₘₐₓ is a system-defined maximum current that does not produce excessive copper ions, and Nₘₐₓ is a maximum number of sampling periods when the current reaches Iₘₐₓ;
if so, controlling the electrode assembly (2) to undergo polarity reversal; and
if not, repeating step S2 and step S3.

13. The polarity reversal method of a solar-powered copper ion generator according to claim 12, wherein in step S4, residual current is eliminated before the polarity reversal is performed, specifically including the following steps:
step S41: residual current elimination: eliminating the residual current in the electrode assembly (2) by discharge for a time T₂ or by fast pulse inversion.

14. The polarity reversal method of a solar-powered copper ion generator according to claim 12, wherein Iₘₐₓ=60-80 mA.

15. A polarity reversal method of a solar-powered copper ion generator, implemented based on the solar-powered copper ion generator according to claim 11, wherein by detecting or calculating a copper ion concentration Iₘ near a cathode in the electrode assembly (2), a polarity reversal time of the electrode assembly (2) is determined based on the copper ion concentration Fₘ; and the method specifically comprises the following steps:
step A1: power-on: supplying power to the electrode assembly (2) by a current control unit (147), and controlling a current direction as from a first electrode (22) to a second electrode (23);
step A2: calculation of Fₘ: respectively detecting, by the current detection unit (141) and the voltage detection unit (143), an actual current Iₘ and an actual voltage Uₘ of the second electrode (23) at T₃ time intervals, calculating Fₘ based on
$${F}_{m} = \frac{{I}_{m}}{{U}_{m}} ,$$
and recording a number of tests N and corresponding Fₘ;
step A3: determining whether N is greater than 2;
if so, performing a next step; and
if not, repeating step A2;
step A4: acquisition of K and R²: fitting a linear function of N Fₘ values by a least square method to obtain Fₘ=Kt+b, with a goodness of fit R²; and
step A5: determining whether K<−8.235,0.85≤R²<1;
if so, controlling the electrode assembly (2) to undergo polarity reversal; and
if not, repeating step A2 to step A4.

16. An electrode depletion determination method of a solar-powered copper ion generator, implemented based on the solar-powered copper ion generator according to claim 10, wherein when a ratio of a consumed mass M of an electrode assembly (2) to a preset initial mass Mᵢₙᵢₜᵢₐₗ of the electrode assembly (2) reaches a predetermined threshold, it is determined that the electrode is depleted and an alarm is given; and the method specifically comprises the following steps:
step B1: current detection: detecting and recording, by the current detection unit (141), an actual current I_{τ} of the electrode assembly (2) at T₄ time intervals;
step B2: calculation of M: accumulating, based on
$$M = \frac{{\sum }_{τ = 1}^{N} {I}_{τ} {T}_{4}}{{K}_{1}} \cdot {K}_{2} ,$$
the electric charge passed in each time interval to obtain the total electric charge, and converting the total electric charge into the consumed mass to calculate M; and
step B3: determining whether
$$\frac{M}{{M}_{initial}}$$
reaches the predetermined threshold;
if so, determining that the electrode is depleted and an alarm is given; and
if not, repeating step B1 and step B2.

17. The electrode depletion determination method of a solar-powered copper ion generator according to claim 16, wherein when the predetermined threshold is 90%, it is determined that the electrode is depleted.
